(19) United States
(12) Patent Application Publication
(10) Pub. No.: US 2025/0373917 A1
(43) Pub. Date: Dec. 4, 2025

(54) IMAGE CAPTURING APPARATUS HAVING IMAGE BLUR CORRECTION MECHANISM

(71) Applicant: CANON KABUSHIKI KAISHA, Tokyo (JP)

(72) Inventor: TAKASHI YOSHIDA, Tokyo (JP)

(21) Appl. No.: 19/215,931

(22) Filed: May 22, 2025

(30) Foreign Application Priority Data
May 31, 2024 (JP) 2024-088622

(51) Int. Cl. H04N 23/52; H04N 23/68

(52) U.S. Cl. CPC H04N 23/52; H04N 23/687

(57) ABSTRACT

An image capturing apparatus having a fixed part and a movable part holding an image sensor and supported by the fixed part with a fixed spacing between the movable part and the fixed part in a photographing optical axis direction in a state movable within a plane parallel to an imaging surface of the image sensor. The movable part is driven relative to the fixed part. A sheet-shaped heat dissipation member connects between the movable part and the fixed part. A thickness direction in respective fixed areas, fixed to the movable part and the fixed part, of the heat dissipation member is parallel to the photographing optical axis. A deformed portion of the heat dissipation member except the fixed areas is not brought into contact with the movable part or the fixed part whichever position in a driving control range, the movable part is in.

### BACKGROUND

### Field of the Technology

The present disclosure relates to an image capturing apparatus having an image blur correction mechanism that displaces an image sensor.

### Description of the Related Art

As an image capturing apparatus, such as a digital still camera or a video camera, an apparatus has come into wide use, which is equipped with an image blur correction mechanism that corrects an image blur by displacing (swinging) an image sensor within a plane orthogonal to a photographing optical axis, so as to improve image quality. Here, the image sensor, such as a CMOS sensor, generates heat during its operation. To cope with this, a cooling mechanism for preventing the temperature of the image sensor from exceeding an operation guaranteed temperature is needed, and hence there is a demand for a cooling mechanism that efficiently cools the image sensor without increasing a driving load during driving of the image blur correction mechanism. To meet the demand, PCT International Patent Publication No. WO2020/202811 discloses a technique in which a thickness direction of a bendable heat transfer member, which connects between a movable part and a fixed part of an image blur correction mechanism, is set to a direction orthogonal to the photographing optical axis to thereby reduce a driving load during driving of the image blur correction mechanism that displaces the movable part having an image sensor.

In the above-mentioned PCT International Patent Publication No. WO2020/202811, there is no disclosure of a relationship of the heat dissipation member with peripheral members with respect to the dimensions of width and length thereof. Therefore, for example, in a case where the shape and arrangement position of the heat transfer member are designed placing importance on the cooling performance, the driving load applied during driving of the image blur correction mechanisms that displaces the movable part having the image sensor can be increased.

### SUMMARY

The present disclosure is directed to provide an image capturing apparatus that is capable of obtaining sufficient performance of cooling an image sensor without increasing a load of image blur correction driving.

In a first aspect of the present disclosure, there is provided an image capturing apparatus including a fixed part, a movable part that holds an image sensor, and is supported by the fixed part with a fixed spacing between the movable part and the fixed part in a photographing optical axis direction in a state movable within a plane parallel to an imaging surface of the image sensor, a drive unit configured to drive the movable part relative to the fixed part, and a heat dissipation member that has a sheet shape and connects between the movable part and the fixed part, wherein the heat dissipation member has fixed areas fixed to the movable part and the fixed part, respectively, a thickness direction of the fixed areas being parallel to the photographing optical axis, and wherein a deformed portion of the heat dissipation member except the fixed areas is not brought into contact with the movable part or the fixed part, whichever position in a driving control range of the movable part, the movable part is in.

In a second aspect of the present disclosure, there is provided An image capturing apparatus including a fixed part, a movable part that holds an image sensor, and is supported by the fixed part with a fixed spacing between the movable part and the fixed part in a photographing optical axis direction in a state movable within a plane parallel to an imaging surface of the image sensor, and a heat dissipation member that connects between the movable part and the fixed part, wherein the heat dissipation member has a first curved portion, a second curved portion, and a third curved portion, which each maintain a curved shape in a free state, wherein the first curved portion is located in a substantially middle position in the photographing optical axis direction in the spacing, in a state in which the image sensor is in an optical axial center position, the second curved portion is located in the vicinity of a side of the movable part, and the third curved portion is located in the vicinity of a side of the fixed part, and wherein a first relational expression: L<[{(X/2)+(Z²/2X)−(Zr/X)}²+r²]^{0.5}, and a second relational expression: W<(Z−2R)/sin {(tan⁻¹(Y/D)} are satisfied, wherein X represents a driving amount of the movable part in a first direction on the plane, Y represents a driving amount of the movable part in a second direction orthogonal to the first direction on the plane, r represents a distance between an end point, toward the movable part, of the third curved portion, and the surface, opposed to the movable part, of the fixed part, R represents a distance in the photographing optical axis between an intersection of an extension of a straight line connecting between an end point, toward the fixed part, of the second curved portion, and an end point, toward the movable part, of the first curved portion, and an extension of a straight line connecting between an end point, toward the movable part, of the third curved portion, and an end point, toward the fixed part, of the first curved portion, and the end point, toward the movable part, of the first curved portion, D represents a distance between the fixed area, to which the heat dissipation member is fixed, of the movable part, and the fixed area, to which the heat dissipation member is fixed, of the fixed part, in the photographing optical axis direction, L represents a distance from the end point, toward the movable part, of the third curved portion, to the intersection, and W represents a width of the heat dissipation member.

According to the present disclosure, it is possible to obtain sufficient performance of cooling the image sensor without increasing a load of image blur correction driving.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a schematic configuration of an image capturing system according to an embodiment.

FIG. 2 is an exploded perspective view of the image capturing system.

FIGS. 3A and 3B are exploded perspective views of an image capturing section.

FIGS. 4A to 4C are schematic cross-sectional views useful for explaining a state of a heat dissipation member at a time when a movable part is displaced in an x direction.

FIGS. 5A and 5B are schematic cross-sectional views each showing a state of the heat dissipation member at a time when the movable part is displaced in a y direction.

FIGS. 6A to 6C are schematic cross-sectional views each showing a variation of an arrangement form of the heat dissipation member.

FIG. 7 is a perspective view showing a first variation of the heat dissipation member.

FIG. 8 is a cross-sectional view showing a second variation of the heat dissipation member.

### DESCRIPTION OF THE EMBODIMENTS

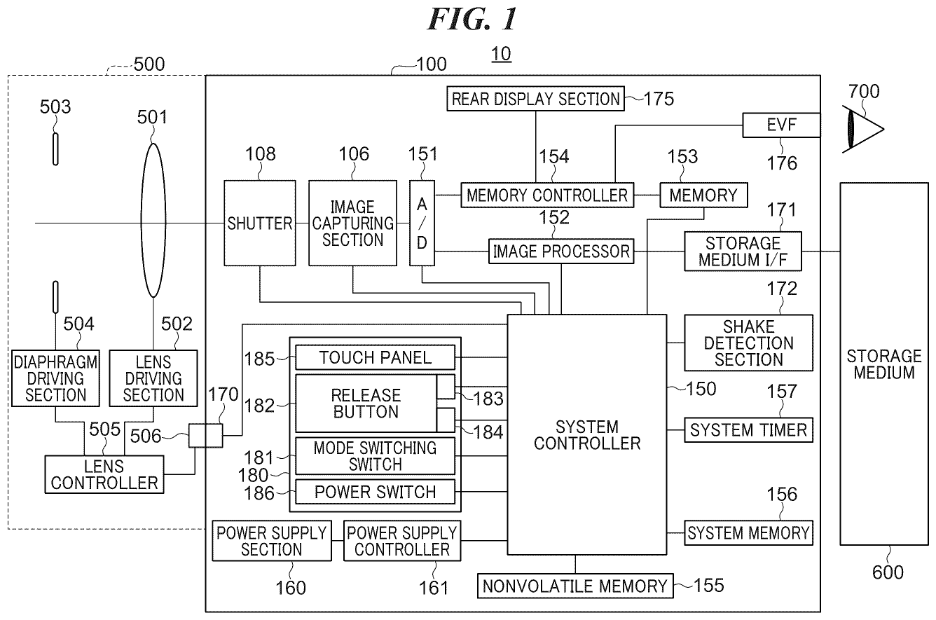

The present disclosure will now be described in detail below with reference to the accompanying drawings showing embodiments thereof. FIG. 1 is a block diagram showing a schematic configuration of an image capturing system 10 according to an embodiment. The image capturing system 10 is roughly comprised of an image capturing apparatus 100 and a lens device 500 which can be removably attached to the image capturing apparatus 100. The image capturing system 10 is, specifically, a digital camera that is capable of photographing a still image and a moving image. The lens device 500 is a so-called interchangeable lens.

The image capturing apparatus 100 includes a shutter 108, an image sensor 115, a system controller 150, an analog-to-digital (A/D) converter 151, an image processor 152, a memory 153, a memory controller 154, a nonvolatile memory 155, a system memory 156, and a system timer 157. Further, the image capturing apparatus 100 includes a power supply section 160, a power supply controller 161, a camera communication terminal 170, a shake detection section 172, a storage medium interface (I/F) 171, a rear display section 175, an electronic view finder (EVF) display section 176, and an operation section 180. Further, a storage medium 600 can be removably attached to the image capturing apparatus 100. The lens device 500 includes a lens 501, a lens driving section 502, a diaphragm 503, a diaphragm driving section 504, a lens controller 505, and a lens communication terminal 506.

In the image capturing apparatus 100, the shutter 108 is a focal plane shutter that controls an exposure time of the image sensor 115, and the operation of the shutter 108 is controlled by the system controller 150. The image sensor 115 is e.g. a complementary metal oxide semiconductor (CMOS) sensor, and generates analog image capturing signals by photoelectrically converting an object image (optical image) formed by light incident through the lens device 500 to output the analog image capturing signals to the A/D converter 151. The A/D converter 151 converts the analog image capturing signals transmitted from the image sensor 115 to digital image capturing signals. The digital image capturing signals are transmitted to the image processor 152 and further written into the memory 153 via the memory controller 154. The image processor 152 performs image processing, such as pixel interpolation processing, resizing, and color conversion processing, on the digital image capturing signals transmitted from the A/D converter 151 or the memory controller 154 to generate image data. Further, the image processor 152 executes e.g. automatic white balance (AWB) processing based on a result of calculation using the image data.

The system controller 150 is a computer (micro processor unit (MPU)) including a processor, such as a CPU, and a circuit, and controls the overall operation of the image capturing system 10 by executing programs stored in the nonvolatile memory 155. The system controller 150 controls the operations of the image sensor 115 and the shutter 108 e.g. according to an image capturing instruction provided by a user, and further, performs autofocus (AF) control and auto exposure (AE) control based on the image data generated by the image processor 152.

The memory 153 temporarily stores the digital image capturing signals output from the A/D converter 151 and the image data generated by the image processor 152. Note that the memory 153 also functions as an image display memory (video memory). The memory controller 154 controls transfer of data between the A/D converter 151, the image processor 152, and the memory 153. The nonvolatile memory 155 is an electrically erasable and recordable storage medium, such as an electrically erasable programmable read-only memory (EEPROM), and stores constants for the operation of the system controller 150, programs, and so forth. The system memory 156 is a storage medium storing a program loaded from the nonvolatile memory 155, the constants and variables for the operation of the system controller 150, and so forth, and it is possible to read data therefrom and write data therein.

The system timer 157 measures non-operation time before performing automatic power-off for shifting the image capturing system 10 to a power-saving state to prevent wasteful consumption of a battery in a case where the image capturing system 10 is not operated by the user, and exposure time to the image sensor 115 using the shutter 108. The power supply section 160 is formed by a primary battery, a secondary battery, or an alternating current (AC) adapter. The power supply controller 161 determines whether or not a battery is attached to the power supply section 160 and a type of an attached battery, detects a remaining amount of the battery, and supplies necessary volage to a variety of components at necessary timings.

The camera communication terminal 170 is electrically connected to the lens communication terminal 506 of the lens device 500, and with this connection, bidirectional communication between the system controller 150 and the lens controller 505 of the lens device 500 is enabled. The storage medium I/F 171 is an interface for enabling communication between the storage medium 600 attached to the image capturing apparatus 100 and the system controller 150. The storage medium 600 is a memory card, a flash memory, a hard disk, or the like, which can be removably attached to the image capturing apparatus 100 and stores (saves) image data of a still image and a moving image, generated by the image processor 152. The shake detection section 172 is comprised of a gyro sensor, and outputs a signal corresponding to a shake generated in the image capturing system 10 (shake and vibration), caused e.g. by a hand shake.

The rear display section 175 provided on the rear side of the image capturing apparatus 100 and the EVF display section 176 disposed in the finder each have a liquid crystal panel, an organic EL panel, or the like, and display a live view image, an image for confirming captured image, and a menu screen for making a variety of settings for the image capturing system 10.

The operation section 180 receives an operation performed by the user and outputs a signal corresponding to a received operation to the system controller 150. The operation section 180 includes a mode switching switch 181, a first shutter switch 183 and a second shutter switch 184, which are interlocked with a release button 182, a touch panel 185, and a power switch 186 by way of example. The mode switching switch 181 is an operation member for switching still image photographing and moving image photographing. The release button 182 is an operation member used by the user to provide a photographing preparation instruction and a photographing instruction. When the release button 182 is half-pressed, the first shutter switch 183 is turned on to output a SW1 signal to the system controller 150. When the release button 182 is fully pressed, the second shutter switch 184 is turned on to output a SW2 signal to the system controller 150. Upon receipt of the SW1 signal, the system controller 150 executes the photographing preparation operation (including AF processing, AE processing, and AWB processing), and upon receipt of the SW2 signal, executes processing for photographing an image for recording. The touch panel 185 is disposed on the rear display section 175, and outputs to the system controller 150 a signal for executing an operation corresponding to a touch operation performed on e.g. an icon displayed on the rear display section 175. The power switch 186 is an operation member for switching power-on/off of the image capturing system 10.

Although in the lens device 500, only one lens 501 is illustrated in FIG. 1 for simplification, in actuality, the lens 501 is comprised of a plurality of lenses, such as a focus lens, a zoom lens, and an image blur correction lens. The lens driving section 502 drives the lens 501 according to a command from the lens controller 505. The diaphragm 503 adjusts an amount of incident light to the image capturing apparatus 100. The diaphragm driving section 504 drives the diaphragm 503 according to a command from the lens controller 505. The lens communication terminal 506 is electrically connected to the camera communication terminal 170, which makes it possible to perform bidirectional communication between the system controller 150 and the lens controller 505. The lens controller 505 controls driving of the lens driving section 502 and the diaphragm driving section 504 based on control signals transmitted from the system controller 150.

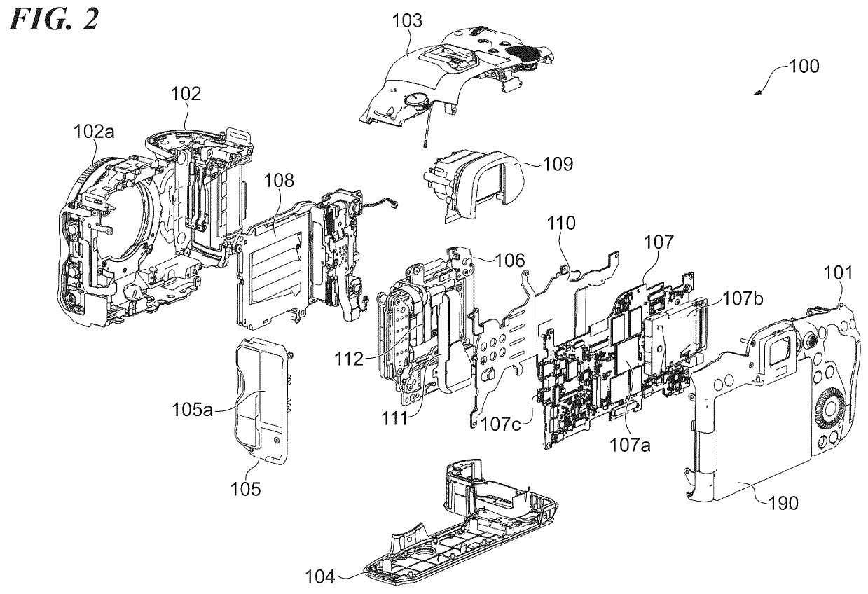

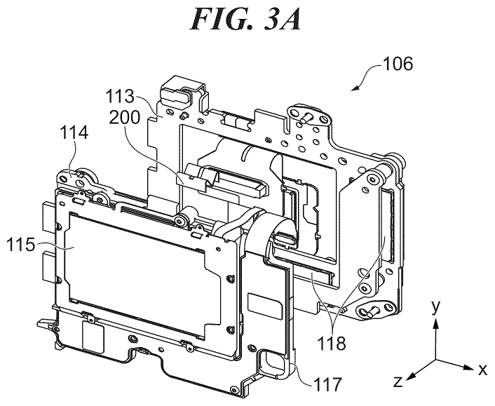

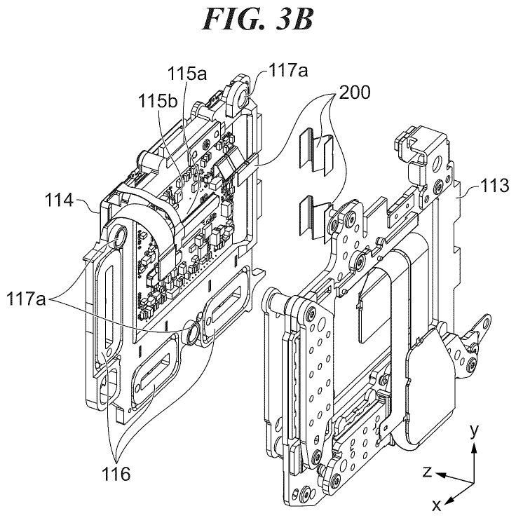

FIG. 2 is an exploded perspective view of the image capturing apparatus 100. The image capturing apparatus 100 has, as exterior members, a front base 102, a rear cover 101, a top cover 103, a bottom cover 104, and a side cover 105. Inside these exterior members of the image capturing apparatus 100, an image capturing section 106 having the image sensor 115 (see FIGS. 3A and 3B) and an image blur correction mechanism, a main board 107, the shutter 108, and a chassis 110 are arranged.

The front base 102 is formed of magnesium diecast or resin, and is provided with a mount 102a to which the lens device 500 is attached. Further, the front base 102 is formed with a grip part as part used by the user to grip the image capturing apparatus 100. On the rear cover 101, a plurality of operation members which can be operated by the user and a vari-angle rear monitor 190 having the rear display section 175 are mounted. A finder unit 109 is mounted on the rear cover 101. The user can check contents displayed on the EVF display section 176 by bringing an eye 700 (see FIG. 1) close to the finder unit 109. On the top cover 103, the plurality of operation members (the mode switching switch 181, the release button 182, the power switch 186, and so forth) which can be operated by the user are provided. The bottom cover 104 has a battery cover which covers an opening of a battery chamber forming the power supply section 160 and further has an opening for exposing a tripod mount provided on the bottom of the front base 102. The side cover 105 is provided with a terminal cover 105a for protecting an external communication terminal 107c mounted on the main board 107.

The main board 107 is formed by mounting a plurality of circuit elements (electronic components and electrical components) on both sides of a multilayer board. The circuit elements mounted on the main board 107 include the A/D converter 151, the image processor 152, the system controller 150 (MPU 107a), the memory 153, the memory controller 154, the nonvolatile memory 155, and the system memory 156. Further, the system timer 157, the power supply controller 161, the storage medium I/F 171, and the shake detection section 172 are also mounted on the main board 107. Further, a recording medium connector 107b connected to the storage medium 600 and the external communication terminal 107c for connecting a cable used to connect to an external apparatus are mounted on the main board 107. The main board 107 is fixed to the front base 102 and the chassis 110 made of metal with screws.

An image capturing signal flexible printed circuit (FPC) 111 and an image capturing power supply FPC 112 are connected to the main board 107. The image capturing signal FPC 111 connects between main board 107 and the image capturing section 106, and transfers an image capturing signal output from the image sensor 115 and a control signal necessary for driving the image sensor 115, between the system controller 150 and the image sensor 115. The image capturing power supply FPC 112 supplies power for driving the image sensor 115 from the power supply controller 161 on the main board 107, to the image sensor 115.

FIGS. 3A and 3B are exploded perspective views of the image capturing section 106, which show the image capturing section 106 as viewed from the respective opposite directions. The image capturing section 106 is roughly formed by a movable part 114 and a fixed part 113. An x-axis, a y-axis, and a z-axis, which are orthogonal to each other, are defined as illustrated in FIGS. 3A and 3B. The z-axis is parallel to the photographing optical axis direction, and when the z-axis and the x-axis are parallel to a horizontal direction, the y-axis is parallel to a vertical direction. In other words, the z direction is a front-rear direction of the image capturing apparatus 100, the x direction is a width direction of the image capturing apparatus 100, and the y direction is a height direction of the image capturing apparatus 100.

The movable part 114 is comprised of the image sensor 115 and a sensor holder 117 holding the image sensor 115. The image sensor 115 is formed by adhesively fixing a sensor chip having a plurality of pixels to an imaging board 115a and electrically connecting electrodes of the sensor chip and a circuit formed on the imaging board 115a by wire bonding. On a surface of the imaging board 115a, opposite from the surface to which the sensor chip is adhesively fixed, there are mounted sensor electronic elements 115b, such as capacitors, resistors, and regulators, which form the circuit of the imaging board 115a.

The movable part 114 is supported on the fixed part 113 with a fixed spacing therefrom in a state displaceable (movable) within a plane orthogonal to the photographing optical axis (optical axis of the lens device 500). The fixed part 113 is a supporting member supporting the movable part 114 in a displaceable state and is fixed to the front base 102 of the image capturing apparatus 100.

Positioning of the movable part 114 with respect to the fixed part 113 in the optical axis direction is realized by the following configuration: Three coils 116 are fixed to the sensor holder 117, and three magnets 118 are fixed to the fixed part 113 at respective locations opposed to the three coils 116 in the photographing optical axis direction. Further, three ball holding portions 117a are provided at respective locations on a surface, opposed to the fixed part 113, of the sensor holder 107, and rolling balls (not shown) are arranged in the three ball holding portions 117a. The movable part 114 is held in a state attracted toward the fixed part 113 by the magnetic forces of the magnets 118 and thereby positioned with respect to the fixed part 113 in the photographing optical axis direction.

In the image capturing section 106, the Lorentz force generated between the three coils 116 and the three magnets 118 is controlled by controlling energization of the three coils 116. With this, it is possible to swing (displace) the movable part 114 within a plane orthogonal to the photographing optical axis, i.e. within a plane parallel to the imaging surface of the image sensor 115 via the rolling balls. The system controller 150 performs image blur correction driving for controlling energization to the coils 116 so as to displace the movable part 114 in a direction in which an image blur caused by a hand shake is reduced, according to a direction and a magnitude of e.g. a hand shake detected by the shake detection section 172.

Next, a heat dissipation configuration for dissipating heat from the image sensor 115 to the outside will be described. The image sensor 115 is particularly large in power consumption in the components of the image capturing apparatus 100, and hence generates a large amount of heat, causing its temperature to easily rise. The photographable time of the image capturing system 10 is limited by the operation-guaranteed temperature of the image sensor 115 in a case where the remaining amount of the battery is sufficient. Therefore, to increase the photographable time as much as possible, it is necessary to cool the image sensor 115 so as to prevent the temperature of the image sensor 115 from exceeding the operation-guaranteed temperature.

In the image capturing apparatus 100, three heat dissipation members 200 are arranged between the movable part 114 and the fixed part 113 in a state connecting them. Each heat dissipation member 200 has a sheet-like shape, and is formed e.g. by a graphite sheet laminated e.g. by a PET sheet. Heat generated in the image sensor 115 is transferred to the fixed part 113 via the imaging board 115a holding the image sensor 115, the sensor holder 117, and the heat dissipation members 200, then transferred from the fixed part 113 to the front base 102 fixed e.g. with screws, and finally dissipated to the outside air. By thus releasing heat generated in the image sensor 115 to the outside air, it is possible to suppress temperature rise of the image sensor 115.

The heat dissipation structure using the heat dissipation members 200 is required to have not only the function of suppressing temperature rise of the image sensor 115, but also characteristics that prevent an increase in the load of image blur correction driving or suppress increase of the load to the minimum. Although FIG. 3B shows the configuration in which the three heat dissipation members 200 are arranged, each heat dissipation member 200 is required to have the same characteristics. Therefore, next, relation between the heat dissipation member 200 and image blue correction driving will be described by taking, out of the three heat dissipation members 200, one of the two heat dissipation members 200 arranged at an edge of the image capturing section 106 in the x direction.

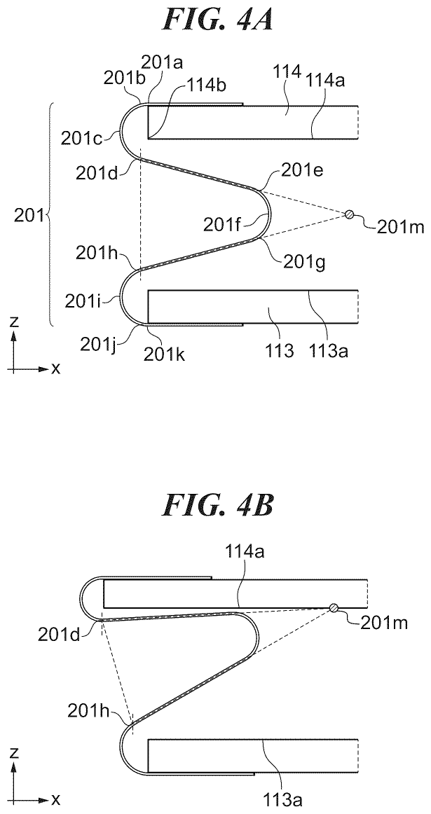

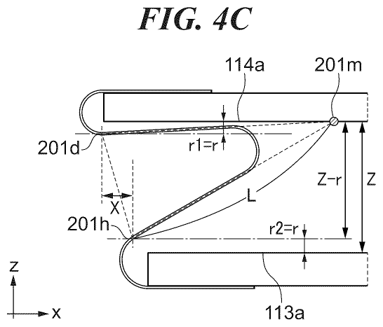

FIGS. 4A to 4C are schematic cross-sectional views each showing an example of a state of the heat dissipation member 200 relative to the movable part 114 and the fixed part 113.

FIG. 4A shows a state in which the movable part 114 is in a reference position (position where the center of the image sensor 115 and the photographing optical axis coincide with each other). FIG. 4B shows a state in which the movable part 114 has been displaced to an end in the −x direction in a control range in the horizontal direction. FIG. 4C shows a state in which the definition of distances between predetermined positions is added to the state shown in FIG. 4B. Note that although FIGS. 4A to 4C show all of the movable part 114, the fixed part 113, and the heat dissipation member 200 in cross section, illustration of hatching indicating a cross section is omitted.

The heat dissipation member 200 is fixed to the movable part 114 and the fixed part 113 with an adhesive in a state stretching over the movable part 114 and the fixed part 113 in the z direction. A portion of the heat dissipation member 200, other than respective portions (fixed areas) adhesively fixed to the movable part 114 and the fixed part 113, forms a deformed portion 201 which is deformed according to the position of the movable part 114. Note that the adhesively fixed portions of the heat dissipation member 200 are parts which are in contact with the movable part 114 and the fixed part 113, respectively, on a plane orthogonal to the z direction. Further, in the heat dissipation member 200, the width of each adhesively fixed portion and the width of the deformed portion 201 are the same.

As shown in FIG. 4A, in the heat dissipation member 200, a thickness direction in the fixed areas fixed to the movable part 114 and the fixed part 113, respectively, is parallel to the photographing optical axis of the image sensor 115, i.e. orthogonal to the imaging surface. Further, with respect to the deformed portion 201, definitions will be given of a movable-side end point 201a, a movable-side first bent portion end 201b, a movable-side second bent portion end 201d, a movable-side bent top 201c, a central movable-side bent portion end 201e, a central fixed-side bent portion end 201g, and a central bent top 201f. Also with respect to the deformed portion 201, definitions will be given of a fixed-side end point 201k, a fixed-side first bent portion end 201j, a fixed-side bent top 201i, and a fixed-side second bent portion end 201h.

The deformed portion 201 has three curved portions, i.e. a curved portion (the movable-side bent top 201c and portions adjacent thereto) in the vicinity of a side of the movable part 114, a curved portion (the fixed-side bent top 201i and portions adjacent thereto) in the vicinity of a side of the fixed part 113, and a curved portion (the central bent top 201f and portions adjacent thereto) in the center of the deformed portion 201. These curved portions are each formed by causing plastic deformation in the heat dissipation member 200 when manufacturing or assembling the heat dissipation member 200 and are each capable of maintaining the curved shape even in a free state in which no external force is applied to the heat dissipation member 200.

Out of the three curved portions, the curved portion in the vicinity of the movable part 114 is disposed outside the side (−X side) of the movable part 114. Similarly, the curved portion in the vicinity of the fixed part 113 is disposed outside the side (−X side) of the fixed part 113. On the other hand, out of the three curved portions, the center curved portion is disposed in a substantially middle position in a space sandwiched between the movable part 114 and the fixed part 113 in the z direction (optical axis direction) when the movable part 114 is in the reference position shown in FIG. 4A, in which the image capturing section 106 is held in an optical axial center position. With this arrangement, it is possible to assemble the heat dissipation member 200 without increasing the size of the image capturing apparatus 100 to the extent possible.

The deformed portion 201 is deformed in accordance with movement of the movable part 114. For example, when the movable part 114 is displaced from the reference position to the end in the −x direction, the deformed portion 201 is deformed from the shape shown in FIG. 4A to the shape shown FIG. 4B. At this time, to prevent the heat dissipation member 200 from increasing the load of image blur correction driving to the extent possible, in the state shown in FIG. 4B, it is necessary to prevent a movable part opposed surface 114a, which is a surface, opposed to the fixed part 113, of the movable part 114, and the deformed portion 201 from being brought into contact with each other. In other words, by preventing the deformed portion 201 from being brought into contact with the movable part 114 even when the deformed portion 201 is deformed in accordance with displacement of the movable part 114, it is possible to avoid increase of the load of image blur correction driving, caused by the contact and friction of the movable part 114 with the heat dissipation member 200, and prevent lowering of the image blur correction performance.

Whether or not contact between the movable part opposed surface 114a and the deformed portion 201 is caused in accordance with displacement of the movable part 114 is synonymous with whether or not the central movable-side bent portion end 201e of the deformed portion 201 is brought into contact with the movable part opposed surface 114a. Further, whether or not the central movable-side bent portion end 201e is brought into contact with the movable part opposed surface 114a depends on a spacing Z between the movable part 114 and the fixed part 113 in the z direction, a displacement distance (also referred to as driving amount or displacement amount) X of the movable part 114, and a length of the deformed portion 201.

The positions of the central movable-side bent portion end 201e and the central fixed-side bent portion end 201g vary with the position of the movable part 114, and hence a virtual point 201m of a central bent portion edge is defined. The virtual point 201m is an intersection of an extension of a straight line connecting between the movable-side second bent portion end 201d and the central movable-side bent portion end 201e, and an extension of a straight line connecting between the fixed-side second bent portion end 201h and the central fixed-side bent portion end 201g. A triangle formed by the movable-side second bent portion end 201d, the fixed-side second bent portion end 201h, and the virtual point 201m is an isosceles triangle because the total length of the heat dissipation member 200 is always constant, and the heat dissipation member 200 has the three curved portions formed by plastic deformation. In other words, a length from the movable-side second bent portion end 201d to the virtual point 201m and a length from the fixed-side second bent portion end 201h to the virtual point 201m are always equal to each other, and each of the lengths is defined as a length L of each virtual straight line portion.

FIG. 4C shows a state in which the virtual point 201m is in contact with the movable part opposed surface 114a. X indicates the displacement amount (driving amount) of the movable part 114 relative to the fixed part 113 in the x direction, and Z indicates a spacing (distance) between the movable part 114 and the fixed part 113 in the z direction. Further, r1 indicates a spacing (distance) between the movable part opposed surface 114a and the movable-side second bent portion end 201d in the z direction, and r2 indicates a spacing (distance) between a fixed part opposed surface (surface, opposed to the movable part 114, of the fixed part 113) 113a and the fixed-side second bent portion end 201h in the z direction. Here, one of the three curved portions is located in substantially the center of the deformed portion 201 from the viewpoint of controllability of the driving load, and hence the spacing r1 and the spacing r2 take substantially the same value r (r1=r2=r).

By using these values, a distance L₁ from the movable-side second bent portion end 201d to the virtual point 201m in the x direction and a distance L₂ from the fixed-side second bent portion end 201h to the virtual point 201m in the x direction are expressed by the following equations (1) and (2), respectively. Further, in a state in which the virtual point 201m and the movable part opposed surface 114a are in contact, a distance from the fixed-side second bent portion end 201h to the virtual point 201m in the z direction is expressed by “Z−r”, and hence a distance L₃ from the fixed-side second bent portion end 201h to the virtual point 201m in the x direction is expressed by the following equation (3). The following equation (5) is derived from the following equation (4) indicating that the distance L₂ and the distance L₃ are equal to each other. To prevent increase of the load of image blur correction driving (prevent the virtual point 201m and the movable part opposed surface 114a from being brought into contact with each other), the heat dissipation member 200 is only required to be designed such that the following relational expression (6) is satisfied. Further, as for the minimum length L₀ of the length L, the deformed portion 201 is required to be deformed, while having an excess length, and hence, from FIG. 4C and the Pythagorean theorem, the minimum length L₀ is only required to be designed such that the following relational expression (7) is satisfied.

$${L}_{1} = \sqrt{{L}^{2} - {r}^{2}} \qquad ( 1 )$$

$${L}_{2} = {L}^{2} - {r}^{2} - X \qquad ( 2 )$$

$${L}_{3} = \sqrt{{L}^{2} - {( Z - r )}^{2}} \qquad ( 3 )$$

$$\sqrt{{L}^{2} - {r}^{2}} - X = \sqrt{{L}^{2} - {( Z - r )}^{2}} \qquad ( 4 )$$

$$L = \sqrt{{( \frac{x}{2} + \frac{{Z}^{2}}{2 X} - \frac{Zr}{X} )}^{2} + {r}^{2}} \qquad ( 5 )$$

$$L < \sqrt{{( \frac{X}{2} + \frac{{Z}^{2}}{2 X} - \frac{Zr}{X} )}^{2} + {r}^{2}} \qquad ( 6 )$$

$${L}_{0} > \frac{\sqrt{{Z}^{2} + {X}^{2}}}{2} \qquad ( 7 )$$

Note that in the present embodiment, the configuration has been described in which the thickness (length in the z direction) of the movable part 114 is smaller than a length, only in the z direction, of the curved portion having the movable-side bent top 201c. On the other hand, in a case where the thickness of the movable part 114 is the larger, the heat dissipation member 200, within a range from the movable-side second bent portion end 201d to the central movable-side bent portion end 201e, is brought into contact with a movable part opposed surface edge portion 114b (see FIG. 4A). This problem can be solved by making the thickness of the movable part 114 locally thinner, only in the vicinity of the heat dissipation member 200, than the length, only in the z direction, of the bent portion of the movable-side bent top 201c.

In a case where the movable part 114 is displaced from the reference position toward an end in the +x direction, the deformed portion 201 is deformed such that the curved portion having the central bent top 201f is displaced toward the fixed part opposed surface 113a. At this time, a condition for preventing the virtual point 201m from being brought into contact with the fixed part opposed surface 113a can be considered to be the same as in the above-described case where the movable part 114 is displaced to the end in the −x direction, and hence description thereof is omitted.

Next, a description will be given of movement of the deformed portion 201 in the heat dissipation member 200 in a case where the movable part 114 is displaced in the y direction which is the height direction of the image capturing apparatus 100 by image blur correction driving. Here, the heat dissipation member 200 shown in FIGS. 4A to 4C, i.e. one of the two heat dissipation members 200 located at the edge of the image capturing section 106 in the x direction will also be described.

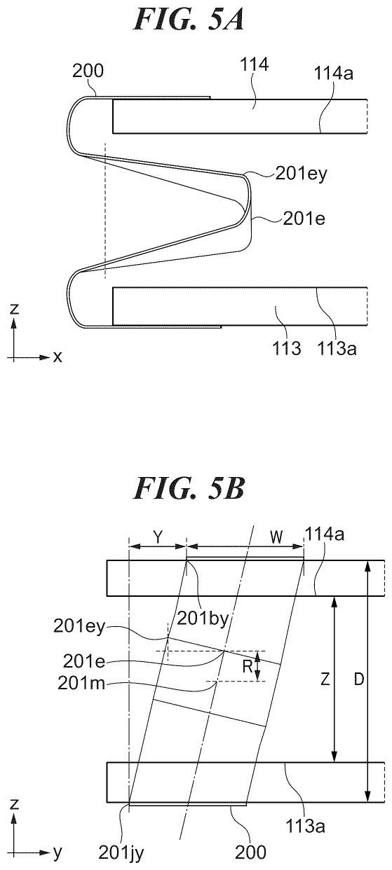

FIG. 5A is a schematic cross-sectional view, as viewed from the −y direction, of a state of the heat dissipation member 200 and its vicinity, at a time when the movable part 114 is displaced to the end in the +y direction (the far side on the drawing sheet of FIG. 5A) in the control range of the heigh direction. FIG. 5B is a schematic cross-sectional view, as viewed from the x direction, of the fixed part 113, the movable part 114, and the heat dissipation member 200 in the state shown in FIG. 5A. Note that although FIG. 5A shows all of the movable part 114, the fixed part 113, and the heat dissipation member 200 in cross section, illustration of hatching indicating a cross section is omitted.

With respect to a case where the movable part 114 is displaced in the y direction, similar to the above-described case where the movable part 114 is displaced in the x direction, a scene in which the deformed portion 201 is brought into contact with the movable part opposed surface 114a is considered. The state of the deformed portion 201 in the reference state in which image blur correction driving is not performed is as shown in FIG. 5A.

As shown in FIG. 5B, W represents a width (width in the y direction) of the heat dissipation member 200, D represents a distance between the respective surfaces of the fixed part 113 and the movable part 114, to which the heat dissipation member 200 is adhesively fixed, R represents a distance between the central movable-side bent portion end 201e and the virtual point 201m in the z direction, and Y indicates the displacement amount (driving amount) of the movable part 114 relative to the fixed part 113 in the y direction. Further, an end of the movable-side first bent portion end 201b in the y direction is defined as a movable-side first bent portion upper end 201by, an end of the central movable-side bent portion end 201e in the y direction is defined as a central movable-side bent portion upper end 201ey, and an end of the fixed-side first bent portion end 201j in the y direction is defined as a fixed-side first bent portion upper end 201jy.

In accordance with displacement of the movable part 114 in the y direction, similar to the movable part 114, the movable-side first bent portion upper end 201by is also displaced in the y direction, and hence the whole deformed portion 201 is tilted by “tan⁻¹(Y/D)”. At this time, between the central movable-side bent portion end 201e and the central movable-side bent portion upper end 201ey, a difference is generated in the position in the z direction by “(W/2)×sin {tan⁻¹(Y/D)}. Assuming that the central movable-side bent portion upper end 201ey is brought into contact with the movable part opposed surface 114a, the difference in the z direction between the central movable-side bent portion end 201e and the central movable-side bent portion upper end 201ey becomes equal to “(Z/2)−R”, and hence the following equation (8) is derived. To prevent the driving load of image blue correction from being increased (prevent the central movable-side bent portion upper end 201ey from being brought into contact with the movable part opposed surface 114a), the heat dissipation member 200 is only required to be designed such that a relationship expressed by the following relational expression (9) is satisfied.

Note that a case where the movable part 114 is displaced in the −y direction is the same as the case where the movable part 114 is displaced in the +y direction, and hence description thereof is omitted. Further, the heat dissipation member 200 has the belt-like shape which is uniform in the width W, and hence the width W of the heat dissipation member 200 is equal to the width of the deformed portion 201, but a heat dissipation member having an adhesively fixed portion and a deformed portion, which are different in width, can also be used, and in this case, the width of the deformed portion is used as the width W.

$$w = \frac{Z - 2 R}{sin ( {tan}^{- 1} \frac{Y}{D} )} \qquad ( 8 )$$

$$w < \frac{Z - 2 R}{sin ( {tan}^{- 1} \frac{Y}{D} )} \qquad ( 9 )$$

Thus, it is possible to design the form (L, W) of the deformed portion 201 which does not impair image blur correction driving by using parameters indicating the arrangement (Z, D) of the movable part 114 and the fixed part 113, the driving amounts (X, Y) of the movable part 114, and the rigidity (r, R) of the heat dissipation member 200, respectively.

Thus far, although the case where the movable part 114 is displaced to the endmost position of the driving control range of image blur correction has been described, in general, the movable range of the movable part 114 is wider than the driving control range. Therefore, by external force, such as impact applied to the image capturing apparatus 100, the movable part 114 can be moved to a position inside the movable range of image blur correction and at the same time outside the driving control range. In view of this, even in a case where the movable part 114 is displaced to a position inside the movable range of image blur correction and at the same time outside the driving control range, it is desirable that the above expressions (6), (7), and (9) are satisfied. With this, it is possible to prevent contact of the heat dissipation member 200 with the movable part 114 and the fixed part 113 to thereby prevent the heat dissipation member 200 from being damaged even in a state in which the power of the image capturing system 10 is off.

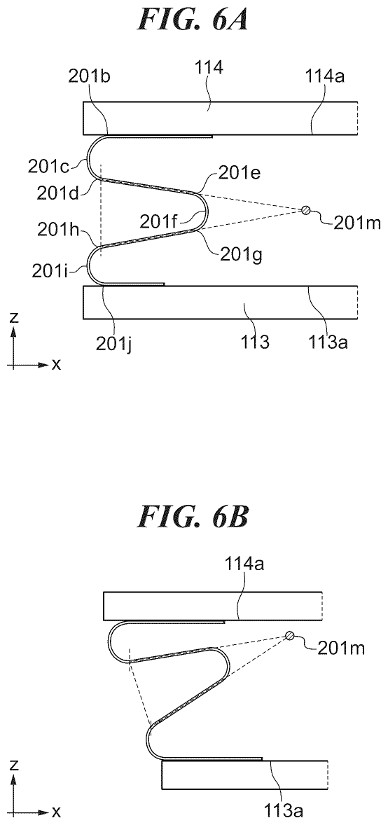

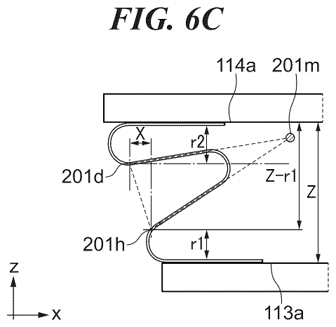

Thus far, the configuration has been described in which the heat dissipation member 200 is fixed to respective surfaces, opposite to the fixed part opposed surface 113a and the movable part opposed surface 114a, of the fixed part 113 and the movable part 114. On the other hand, next, a configuration will be described in which the fixing positions of the heat dissipation member 200 with respect to the fixed part 113 and the movable part 114 are changed to the fixed part opposed surface 113a and the movable part opposed surface 114a. FIGS. 6A to 6C are cross-sectional views each showing a variation of the arrangement form of the heat dissipation member 200. FIG. 6A shows a state in which the movable part 114 is in the reference position, similar to FIG. 4A, and FIG. 6B shows a state in which the movable part 114 has been displaced in the x direction within the control range in the horizontal direction. FIG. 6C shows a state in which the definition of distances between predetermined positions is added to the state shown in FIG. 6B. Note that although FIGS. 6A to 6C show all of the movable part 114, the fixed part 113, and the heat dissipation member 200 in cross section, illustration of hatching indicating a cross section is omitted.

The heat dissipation member 200 is fixed to the movable part opposed surface 114a and the fixed part opposed surface 113a. In this case, as shown in FIG. 6A, the movable-side end point 201a (see FIG. 4A) and the movable-side first bent portion end 201b become the same point, and further, the fixed-side end point 201k (see FIG. 4A) and the fixed-side first bent portion end 201j become the same point, and the points of the deformed portion 201 other than these can be defined, similar to the description given with reference to FIG. 4A.

The deformed portion 201 is deformed as shown in FIG. 6B in accordance with displacement of the movable part 114, and the relationship of the distances between the points of the deformed portion 201 at this time is as shown in FIG. 6C.

The condition for preventing the virtual point 201m from being brought into contact with the movable part opposed surface 114a, which is the condition for suppressing increase of the load of image blur correction driving, is the same as the expression (6), described above with reference to FIG. 4C. Note that although FIGS. 6B and 6C show the state in which the virtual point 201m is not in contact with the movable part opposed surface 114a, the spacings r1 and r2 in FIG. 6C take substantially the same value r, in a state in which the virtual point 201m is in contact with the movable part opposed surface 114a.

On the other hand, the width W of the heat dissipation member 200 becomes the same as in the case where “D=Z” is set in FIG. 5C. Therefore, the condition of the following relational expression (10) derived by setting “D=Z” in the above relational expression (9) is satisfied, whereby it is possible to prevent the central movable-side bent portion upper end 201ey from being brought into contact with the movable part opposed surface 114a.

$$w < \frac{Z - 2 R}{sin ( {tan}^{- 1} \frac{Y}{Z} )} \qquad ( 10 )$$

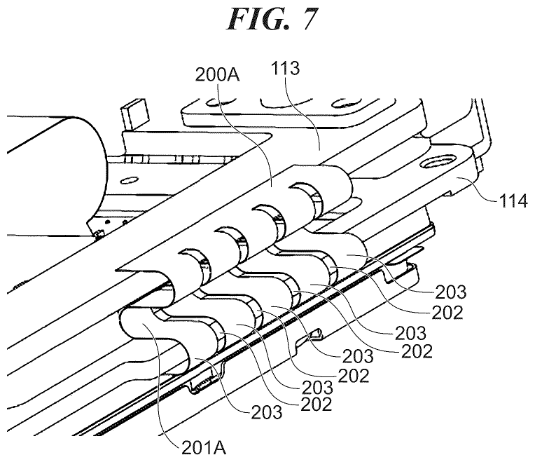

Next, a heat dissipation member 200A as a first variation of the heat dissipation member 200 will be described. FIG. 7 is a perspective view showing a state in which the heat dissipation member 200A has been attached to the fixed part 113 and the movable part 114. The heat dissipation member 200A has a laminated structure formed by a plurality of resin sheets (such as PET sheets) and graphite sheets, and does not have a signal line. A deformed portion 201A of the heat dissipation member 200A, corresponding to the deformed portion 201 of the heat dissipation member 200, is formed with a plurality of slits 202 for reducing the load of the heat dissipation member 200A due to displacement (swinging) of the movable part 114, such that the slits 202 extend in a direction of the length of the heat dissipation member 200A. Part of the deformed portion 201A other than the plurality of slits 202 forms belt-shaped portions 203 each including the graphite sheet, the graphite sheets laminated in the belt-shaped portions 203 are deformable independently from each other.

The width of each slit 202 is set to a value at which the adjacent belt-shaped portions 203 are prevented from being brought into contact with each other even when the movable part 114 is displaced to the endmost position of the driving control range so as to prevent the load of image blur correction driving from being increased by contact between the adjacent belt-shaped portions 203. Note that all of the plurality of belt-shaped portions 203 are not required to have the same length and width, but from the viewpoint of the controllability in image blur correction, it is desirable that all of the plurality of belt-shaped portions 203 are not brought into contact with the movable part opposed surface 114a and the fixed part opposed surface 113a. That is, the length and the width of each of the plurality of belt-shaped portions 203 are required to satisfy the above expressions (6) and (9) (or (10)).

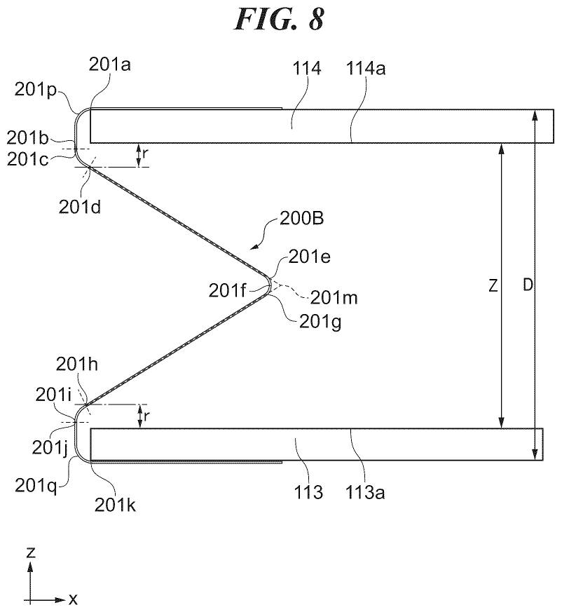

Next, a heat dissipation member 200B as a second variation of the heat dissipation member 200 will be described. Similar to FIG. 4A, FIG. 8 is a cross-sectional view showing the arrangement state of the heat dissipation member 200B, in a state in which the movable part 114 is in the reference position. The heat dissipation member 200B has five curved portions which have been plastically deformed. Specifically, the heat dissipation member 200B has not only the three plastically deformed curved portions of the heat dissipation member 200, but also a fourth curved portion 201p which is bent from an end of the movable part 114 such that the fourth curved portion 201p extends along the side of the movable part 114, and a fifth curved portion 201q which is bent from an end of the fixed part 113 such that the fifth curved portion 201q extends along the side of the fixed part 113. By arranging the fourth curved portion 201p and the fifth curved portion 201q, it is possible to reduce the dimension of the heat dissipation member 200B in the x direction, and with this, it is possible to reduce the size of the image capturing apparatus 100.

With respect to the heat dissipation member 200B, as shown in FIG. 8, similar to the deformed portion 201 of the heat dissipation member 200, when deformation ends (201a, 201k), bending start ends (201b, 201e/201g, 201j), bending most protruding portions (201c, 201f, 201i), bending termination ends (201d, 201e/201g, 201h), and a virtual point (201m) are defined, the relationship between these is the same as that of the deformed portion 201. Therefore, also in the heat dissipation member 200B, a condition for preventing the virtual point 201m from being brought into contact with the movable part opposed surface 114a to prevent increase of the load of image blur correction driving is expressed by the above expression (6). Further, with respect to the width of the heat dissipation member 200B, similarly, a condition for preventing the central movable-side bent portion upper end 201ey (not shown in FIG. 8, see FIG. 5B) from being brought into contact with the movable part opposed surface 114a is expressed by the above expression (9).

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-088622, filed May 31, 2024, which is hereby incorporated by reference herein in its entirety.

What is claimed is:

1. An image capturing apparatus comprising:
a fixed part;
a movable part that holds an image sensor, and is supported by the fixed part with a fixed spacing between the movable part and the fixed part in a photographing optical axis direction in a state movable within a plane parallel to an imaging surface of the image sensor;
a drive unit configured to drive the movable part relative to the fixed part; and
a heat dissipation member that has a sheet shape and connects between the movable part and the fixed part,
wherein the heat dissipation member has fixed areas fixed to the movable part and the fixed part, respectively, a thickness direction of the fixed areas being parallel to the photographing optical axis, and
wherein a deformed portion of the heat dissipation member except the fixed areas is not brought into contact with the movable part or the fixed part, whichever position in a driving control range of the movable part, the movable part is in.

2. The image capturing apparatus according to claim 1, wherein the movable part is movable in a movable range wider than the driving control range, and
wherein whichever position in the driving control range, the movable part is in, the deformed portion is not brought into contact with the movable part or the fixed part.

3. The image capturing apparatus according to claim 1, wherein the deformed portion has at least one slit formed therein which extends in a direction of a length of the heat dissipation member, and
wherein whichever position in the driving control range, the movable part is in, belt-shaped portions opposed to each other across the slit in the deformed portion are not brought into contact with each other.

4. The image capturing apparatus according to claim 1, wherein the heat dissipation member has at least three curved portions which each maintain a curved shape in a free state, and
wherein one of the three curved portions is located in a substantially middle position in a photographing optical axis direction in the spacing, in a state in which the image sensor is held in an optical axial center position.

5. The image capturing apparatus according to claim 4, wherein the heat dissipation member is fixed to a surface, opposite from a surface opposed to the fixed part, of the movable part, and to a surface, opposite from a surface opposed to the movable part, of the fixed part.

6. The image capturing apparatus according to claim 4, wherein the heat dissipation member is fixed to a surface, opposed to the fixed part, of the movable part, and to a surface, opposed to the movable part, of the fixed part.

7. The image capturing apparatus according to claim 5, wherein the other two curved portions of the three curved portions are located in the vicinity of respective sides of the movable part and the fixed part, and
wherein a first relational expression: L<[{(X/2)+(Z²/2X)−(Zr/X)}²+r²]^{0.5}, and a second relational expression: W<(Z−2R)/sin {(tan⁻¹(Y/D)} are satisfied,
wherein X represents a driving amount of the movable part in a first direction on the plane,
Y represents a driving amount of the movable part in a second direction orthogonal to the first direction on the plane,
Z represents a distance between a surface, to which the heat dissipation member is fixed, of the movable part, and a surface, to which the heat dissipation member is fixed, of the fixed part, in a photographing optical axis direction,
r represents a distance between an end point, toward the movable part, of one, located in the vicinity of a side of the fixed part, of the three curved portions, and the surface, opposed to the movable part, of the fixed part,
R represents a distance in the photographing optical axis between an intersection of an extension of a straight line connecting between an end point, toward the fixed part, of one, located in the vicinity of a side of the movable part, of the three curved portions, and an end point, toward the movable part, of the one, located in the substantially middle position in the photographing optical axis direction in the spacing, in the state in which the image sensor is in the optical axial center position, of the three curved portions, and an extension of a straight line connecting between an end point, toward the movable part, of one, located in the vicinity of the side of the fixed part, of the three curved portions, and an end point, toward the fixed part, of the one, located in the substantially middle position in the photographing optical axis direction, of the three curved portions, and the end point, toward the movable part, of the one, located in the substantially middle position in the photographing optical axis direction, of the three curved portions,
D represents a distance between the fixed area, to which the heat dissipation member is fixed, of the movable part, and the fixed area, to which the heat dissipation member is fixed, of the fixed part, in the photographing optical axis direction,
L represents a distance from the end point, toward the movable part, of the one, located in the vicinity of the side of the fixed part, of the three curved portions, to the intersection, and
W represents a width of the heat dissipation member.

8. The image capturing apparatus according to claim 7, wherein a third relational expression: L₀>(Z²+X²)^{0.5}/2 is satisfied, and
wherein L₀ expresses a minimum distance from the end point, toward the movable part, of the one, located in the vicinity of the side of the fixed part, of the three curved portions, to the intersection.

9. The image capturing apparatus according to claim 8, wherein the heat dissipation member has a plurality of slits extending in a direction of the length of the heat dissipation member, and
wherein whichever position in the driving control range, the movable part is in, belt-shaped portions of the heat dissipation member which are adjacent to each other between the plurality of slits are not brought into contact with each other.

10. The image capturing apparatus according to claim 9, wherein each belt-shaped portion sandwiched between the slits satisfies the first relational expression and the second relational expression.

11. The image capturing apparatus according to claim 1, wherein the heat dissipation member has a laminated structure formed by a plurality of resin sheets and graphite sheets and does not have a signal line.

12. An image capturing apparatus comprising:
a fixed part;
a movable part that holds an image sensor, and is supported by the fixed part with a fixed spacing between the movable part and the fixed part in a photographing optical axis direction in a state movable within a plane parallel to an imaging surface of the image sensor; and
a heat dissipation member that connects between the movable part and the fixed part,
wherein the heat dissipation member has a first curved portion, a second curved portion, and a third curved portion, which each maintain a curved shape in a free state,
wherein the first curved portion is located in a substantially middle position in the photographing optical axis direction in the spacing, in a state in which the image sensor is in an optical axial center position, the second curved portion is located in the vicinity of a side of the movable part, and the third curved portion is located in the vicinity of a side of the fixed part, and
wherein a first relational expression: L<[{(X/2)+ (Z²/2X)−(Zr/X)}2+r²]^{0.5}, and a second relational expression: W<(Z−2R)/sin {(tan⁻¹(Y/D)} are satisfied,
wherein X represents a driving amount of the movable part in a first direction on the plane,
Y represents a driving amount of the movable part in a second direction orthogonal to the first direction on the plane,
r represents a distance between an end point, toward the movable part, of the third curved portion, and the surface, opposed to the movable part, of the fixed part,
R represents a distance in the photographing optical axis between an intersection of an extension of a straight line connecting between an end point, toward the fixed part, of the second curved portion, and an end point, toward the movable part, of the first curved portion, and an extension of a straight line connecting between an end point, toward the movable part, of the third curved portion, and an end point, toward the fixed part, of the first curved portion, and the end point, toward the movable part, of the first curved portion,
D represents a distance between the fixed area, to which the heat dissipation member is fixed, of the movable part, and the fixed area, to which the heat dissipation member is fixed, of the fixed part, in the photographing optical axis direction,
L represents a distance from the end point, toward the movable part, of the third curved portion, to the intersection, and
W represents a width of the heat dissipation member.
